(19) United States
(12) Patent Application Publication
(10) Pub. No.: US 2006/0061838 A1
(43) Pub. Date: Mar. 23, 2006

(54) Image capturing apparatus

(75) Inventor: Yongxiang Yi, Su-Zhou (TW)

Correspondence Address: REED SMITH LLP;ATTN: Juan Carlos A. Marquez, Suite 1400, 3110 Fairview Park Drive, Falls Church, VA, 22042, US

(73) Assignee: BenQ Corporation

(21) Appl. No.: 11/230,468

(22) Filed: Sep. 21, 2005

(30) Foreign Application Priority Data
Sep. 22, 2004 (TW) 93128731

(51) Int. Cl. H04N 1/04

(52) U.S. Cl. 358/487

(57) ABSTRACT

An image capturing apparatus for scanning at least one transparent film is provided. The transparent film has an edge portion and a center portion. The image capturing apparatus includes a window glass and a positioning device selectively located on top of the window glass. The positioning device includes a positioning element defining a space and having a flange. The space is to receive the edge portion of the transparent film, and the flange is to make the transparent film closer to the window glass.

### CROSS REFERENCE TO RELATED APPLICATIONS

This Application claims the right of priority based on Taiwan Patent Application No. 093128731, entitled “Image Capture Apparatus,” filed on Sep. 22, 2004.

### FIELD OF THE INVENTION

The present invention is related to an image capturing apparatus for capturing an image of at least one transparent film. The transparent film is made closer to a window glass by a positioning device of the image capturing apparatus so as to achieve better image clarity.

### BACKGROUND OF THE INVENTION

As the scanning technology has been improving dramatically in the recent years, the need and application to convert images obtained from photographing to digital images have also been widely adopted. Currently, there are a variety of scanners for transparent films, which are used for converting images obtained from this kind of photographing, such as a film, or a negative, to digital images, for consumers to choose. One important factor for a consumer to choose a scanner over another lies in the image quality and clarity obtained by the scanner.

However, image quality and clarity obtained by the scanner are closely related to the optical component adopted by the scanner. Contact image sensors (CIS's) have been widely applied in scanners that can be activated in a shorter time and has a slimmer housing. However, compared to a charge-coupled device (CCD), the image depth of a CIS is relatively short; thus, when scanning, it is necessary to reduce the distance between the scanning object and the window glass so as to obtain a better scanning quality.

When the scanner scans a film or a negative, such transparent film needs to be placed inside a positioning device, such as a film frame or a negative frame, and then the positioning device can be placed in the scanner to start the scanning process. The conventional positioning device usually has a thickness, causing a relatively great distance between the scanning object and the window glass. Besides, because of the gap inside the positioning device, the scanning object can move around inside the positioning device, thereby affecting the image quality obtained during scanning.

An image capturing device with a positioning capability is therefore desirable to overcome the above drawbacks, such that not only can the distance between the scanning object and the window glass be reduced, but also the positioning of the scanning object can be enhanced to improve the scanning quality.

### SUMMARY OF THE INVENTION

The present invention provides an image capturing apparatus for capturing an image of at least one transparent film. The transparent film is made closer to the window glass by a positioning device of the scanner for transparent films so as to obtain better image clarity.

The image capturing apparatus for capturing an image of at least one transparent film in accordance with the present invention includes a window glass and a positioning device located above the window glass. The positioning device includes a positioning element that defines a space and has a flange. The space is for placing the edge portion of the at least one transparent film, while the flange portion is to make the center portion of the transparent film closer to the window glass such that the distance between the window glass and the center portion of the transparent film is minimized, thereby ensuring the scanning quality.

### BRIEF DESCRIPTION OF THE DRAWINGS

FIG. 1 is a schematic view illustrating an image capturing apparatus in accordance with the first embodiment of the present invention;

FIG. 2a is a side view illustrating the image capturing apparatus in accordance with the first embodiment of the present invention;

FIG. 2b is a side view illustrating a positioning element in accordance with the first embodiment of the present invention;

FIG. 3 is a side view illustrating an image capturing apparatus in accordance with the second embodiment of the present invention;

FIG. 4a is a side view illustrating a positioning device in accordance with the third embodiment of the present invention; and

FIG. 4b is a side view illustrating a positioning element in accordance with the third embodiment of the present invention.

### DETAILED DESCRIPTION OF THE INVENTION

The present invention provides an image capturing apparatus for capturing an image of at least one transparent film. A positioning element of the image capturing apparatus makes the transparent film closer to the window glass so as to capture an image with better clarity.

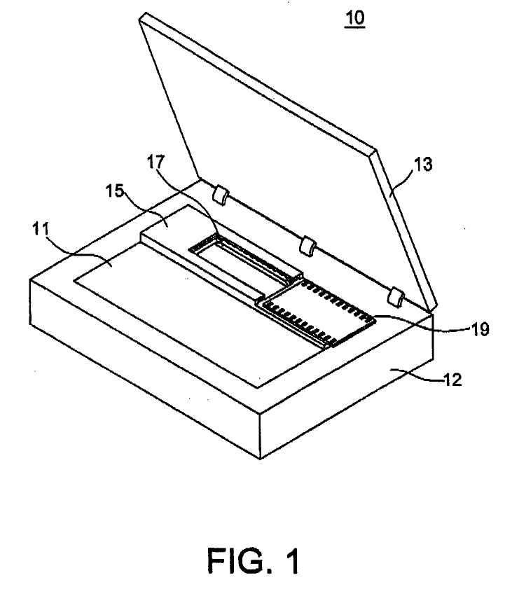

Referring to FIG. 1, the image capturing apparatus 10 in accordance with the first embodiment of the invention has a window glass 11, a lower housing 12, an upper cover 13, a positioning device 15, and a positioning element 17. The positioning device 15 and the positioning element 17 are positioned on the window glass 11. When the lower housing 12 and the upper cover 13 get close to each other, the transparent film 19 is positioned between the positioning device 15 and the window glass 11 so as to capture an image of the transparent film 19. The upper cover 13 can selectively have a light source to be used when capturing an image. The transparent film 19 can also be a plurality of films positioned in the positioning element 17 at the same time so as to save the time spent on positioning the films. Furthermore, positioning the plurality of films can also more easily position the films, reducing the possibility of capturing blurry images. The image capturing apparatus of the present invention is preferably a scanner used to scan an image of the transparent film. However, other image capturing apparatuses with similar functions as the present invention also fall within the scope of the present invention.

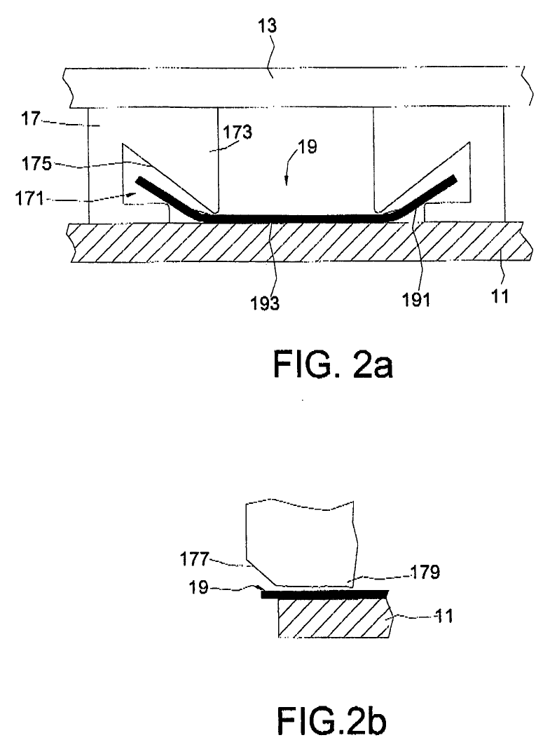

Referring to FIG. 2a, the positioning element 17 in the image capturing apparatus 10 in accordance with the present invention includes a space 171 and a flange portion 173. The space 171 in the positioning element 17 is used for placing the edge portion 191 of the transparent film 19. In accordance with the first embodiment, the flange portion 173 of the image capturing apparatus 10 further includes a first slope 175 next to the space 171. The main function of the flange portion 173 is to make the center portion 193 closer to the window glass 11, while the main function of the first slope 175 is to limit the edge portion 191 of the transparent film 19. In accordance with the first embodiment, the flange portion 173 can be a rectangular block or a trapezoidal block. FIG. 2b is a side view illustrating the positioning element in accordance with the first embodiment of the present invention. As shown in FIG. 2b, the flange portion 173 can also have a guiding slope 177 so as to facilitate entering of the transparent film 19 into the positioning device 15 and to push the edge portion 191 in order to make the center portion 193 closer to the window glass 11 for a better scan quality. The flange portion 173 also has a base 179. The base 179 is a low resistant surface so as to prevent damaging the transparent film 19.

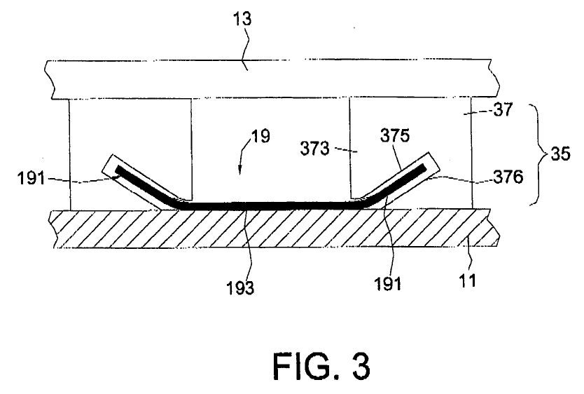

Referring to FIG. 3, the image capturing apparatus 10 in accordance with the second embodiment of the invention includes a positioning element 37 having a first slope 375. When the transparent film 19 is placed in the positioning element 37, the first slope 375 limits the edge portion 191 of the transparent film so as to make the center portion 193 closer to the window glass 11. The positioning element 37 further includes a second slope 376. The second slope 376 is for securing the edge portion 191 of the transparent film 19 such that the transparent film 19 is naturally laid on the second slope 376 and not easily movable. However, in order to make the transparent film 19 closer to the window glass 11, the positioning element 37 further includes a flange portion 373 pushing the transparent film 19 downward. In this manner, when the image capturing apparatus is activated, the distance between the center portion 193 of the transparent film 19 and the window glass 11 is minimized, ensuring the scan quality. In accordance with the second embodiment, the flange 373 can be a rectangular block or a trapezoidal block. The flange portion 373 also has a guiding slope 377, equivalent to the guiding slope 177 shown in FIG. 2b, so as to guide the transparent film 19 to enter the positioning device 35. The flange portion 373 also has a base 379, equivalent to the base 179 shown in FIG. 2b. The base 379 is a low resistant surface to prevent damaging the transparent film 19.

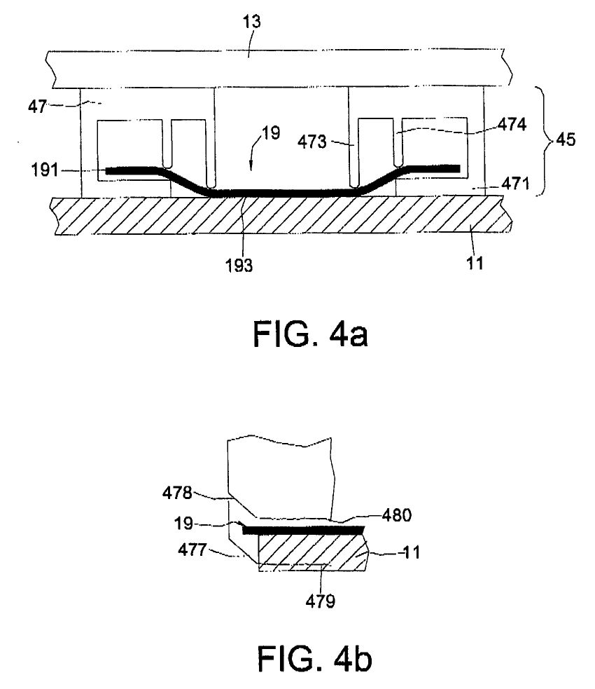

Referring to FIG. 4a that is a side view illustrating the positioning device in accordance with the third embodiment of the present invention, the image capturing device 10 includes a window glass 11, an upper cover 13, a positioning device 45, and a positioning element 47. The positioning device 45 and the positioning element 47 are placed on the window glass 11 to facilitate capturing an image of at least one transparent film 19. The positioning element 47 has a base 471, a first flange portion 473, and a second flange portion 474. The base 471 has a thickness sufficient for helping the first flange portion 473 to push the center portion 193 downward so that the center portion 193 and the base 471 are in line with each other. The second flange portion 474 secures the edge portion 191 of the transparent film 19 such that it cannot be moved easily. When the positioning device 45 is placed on the window glass, the distance between the center portion 193 and the window glass 11 is minimized, ensuring the scan quality. In accordance with the third embodiment, each of the first and the second flange portions 473, 474 can be a rectangular block or a trapezoidal block. Referring to FIG. 4b, the first and the second flange portions 473, 474 can have a guiding slope respectively so as to guide the transparent film 19 to enter into the positioning device 45. The first and the second flange portions 473, 474 can also have a base 479, 480, respectively. Each of the bases 479, 480 is a low resistant surface to prevent damaging of the transparent film 19.

While the invention has been described in connection with what is presently considered to be the most practical and preferred embodiments, it is to be understood that the invention is not to be limited to these embodiments. The invention is intended to cover various modifications and equivalent arrangements within the spirit and scope of the appended claims.

1. An image capturing apparatus, for capturing an image of at least one transparent film, said at least one transparent film having an edge portion and a center portion, said image capturing apparatus comprising:
a window glass; and
a positioning device, selectively located above said window glass, said positioning device including a positioning element, said positioning element defining a space and including a flange, wherein said space is for receiving said edge region, and said flange makes said center portion closer to said window glass.

2. The image capturing apparatus of claim 1, wherein said flange has a slope, allowing said edge portion to get close to said positioning element.

3. The image capturing apparatus of claim 1, wherein said flange has a base.

4. The image capturing apparatus of claim 3, wherein said base is a low resistant surface to prevent damaging said at least one transparent film.

5. The image capturing apparatus of claim 1, wherein said flange has a guiding slope, helping said at least one transparent film to enter said positioning device.

6. The image capturing apparatus of claim 1, wherein said flange is a rectangular block.

7. The image capturing apparatus of claim 1, wherein said flange is a trapezoidal block.

8. An image capturing apparatus for capturing an image of an object having an edge portion and a center portion, said image capturing apparatus comprising:
a window glass; and
a positioning device, selectively located above said window glass, said positioning device including a positioning element for placing said object, said positioning element including a first slope for placing said edge portion to make said center portion closer to said window glass.

9. The image capturing apparatus of claim 8, wherein said positioning element further comprises a second slope to place said edge portion so as to position said object.

10. The image capturing apparatus of claim 8, wherein said positioning element further comprises a flange region.

11. The image capturing apparatus of claim 10, wherein said flange portion includes a base.

12. The image capturing apparatus of claim 11, wherein said base is a low resistance surface to prevent damaging said object.

13. The image capturing apparatus of claim 10, wherein said flange portion includes a guiding slope for guiding said object to enter said positioning device.

14. The image capturing apparatus of claim 10, wherein said flange portion is a rectangular block.

15. The image capturing apparatus of claim 10, wherein said flange portion is a trapezoidal block.

16. A positioning device adopted for an image capturing apparatus, said positioning device positioning at least one transparent film, said transparent film including an edge portion and a center portion, said positioning device comprising:
a positioning element, said positioning element including a first flange portion and a second flange portion;
wherein said positioning element has a base, said base has a thickness, said first flange portion limits said edge portion such that said center portion is aligned with said base, and said second flange portion positions said edge portion.

17. The positioning device of claim 16, wherein said flange portion has a base, said base is a low resistant surface to prevent damaging said at least one transparent film.

18. The positioning device of claim 16, wherein said first and second flange portions have a guiding slope for guiding at least one transparent film to enter said positioning device.

19. The positioning device of claim 16, wherein each of said first and second flange portions is a rectangular block.

20. The positioning device of claim 16, wherein each of said first and second flange portions is a trapezoidal block
